(19) United States
(12) Patent Application Publication
(10) Pub. No.: US 2011/0061081 A1
(43) Pub. Date: Mar. 10, 2011

(54) REFLECTOR APPARATUS FOR VIDEO HOME NETWORKS

(75) Inventor: Alexander Sarapin, Westfield, IN (US)

(73) Assignee: Thomson Licensing LLC, Princeton, NJ (US)

(21) Appl. No.: 12/736,687

(22) PCT Filed: May 2, 2008
(86) PCT No.: PCT/US2008/005774

§ 371 Date: Oct. 29, 2010

(51) Int. Cl. H04N 7/18

(52) U.S. Cl. 725/82

(57) ABSTRACT

A reflector apparatus improves signal quality within video home networks. According to an exemplary embodiment, the reflector apparatus includes a first terminal (A) for receiving a broadcast signal from a signal source, and a second terminal (B) for outputting the broadcast signal to a plurality of external devices coupled to the reflector apparatus via a signal splitter. The reflector apparatus further includes circuitry for receiving a network signal from a first one of the plurality of external devices and controlling a gain of said network signal responsive to a control signal from a second one of the plurality of external devices to thereby generate a reflected network signal. The reflected network signal is output to the second one of said plurality of external devices.

### BACKGROUND OF THE INVENTION

1. Field of the Invention

The present invention generally relates to video home networks, and more particularly, to a reflector apparatus that improves signal quality within video home networks.

2. Background Information

Video home networks are commonly used to distribute media content to various rooms of a home or other dwelling. The infrastructure of such networks typically includes a transmission medium such as coaxial cable coupled to various electronic devices (e.g., televisions, set-top boxes, etc.) via a plurality of signal splitters. As a given network grows in size to is accommodate additional devices, the number of levels of signal splitting may also increase. FIG. 1 is a diagram of an exemplary video home network having three levels of signal splitting.

As indicated in FIG. 1, media content (e.g., audio/video) signals provided from a point-of-entry (POE) can be distributed to various set-top boxes (STB1-STB8) via coaxial cable (RG-59) and various signal splitters (Splitter 1-Splitter 7). Within the video home network of FIG. 1, media content signals may also be transmitted from one set-top box to another. For example, consider the scenario in which a source set-top box (STB1) transmits media content signals to a receiving set-top box (STB8). In this scenario, the signal level at the input of the receiving set-top box (STB8) is based primarily on the sum of two signals, namely a first signal that passes directly from the source set-top box (STB1) to the receiving set-top box (STB8) via the applicable signal splitters (Splitters 1-4 and 7), and a second signal that is reflected from the point-of-entry (POE). Depending on the level of isolation between the respective outputs of the applicable signal splitters and level of the signal reflected from the point-of-entry (POE), three situations can arise: (i) the first signal has a greater signal level than the second signal, (ii) the second signal has a greater signal level than the first signal, and (iii) the first and second signals have approximately the same signal level. In FIG. 1, any given pair of set-top boxes can operate as source/receiving pair. Regardless of which set-top boxes make up the pair, there will always be two s relevant signals, as described above. In these cases, the quality of service within the network (i.e., signal level at receiving device) is adversely affected due to a multi-path problem when the first and second signals have approximately the same signal level (i.e., situation (iii) above). Accordingly, there is a need to provide an apparatus which addresses this multi-path problem in video home networks.

Another issue affecting the quality of service within video home networks relates to the performance of the signal splitters themselves. One challenge of existing networks is to combat signal loss due to the presence of is signal splitters. In general, the better performance a signal splitter provides (i.e., good isolation, good impedance match, etc.) the more difficult it is to provide reliable video networking. The isolation between outputs of signal splitters currently available on market may vary in range, for example, from 10 to 35 dB. Signal splitters with 10 dB isolation between outputs are generally considered to provide poor performance (i.e., poor isolation, poor impedance match, etc.). However, such signal splitters generally provide a favorable level of signal attenuation within a network. Conversely, better isolation between outputs of a signal splitter introduces more signal loss within a network. Accordingly, there is a need to provide an apparatus which is immune to the performance of signal splitters in a video home network.

The invention described herein addresses the aforementioned and/or other problems, and provides a reflector apparatus which improves signal quality within video home networks.

### SUMMARY OF THE INVENTION

In accordance with an aspect of the present invention, an apparatus is disclosed. According to an exemplary embodiment, the apparatus comprises means such as a first terminal for receiving a broadcast signal from a signal source, and means such as a second terminal for outputting the broadcast signal to a plurality of external devices coupled to the apparatus via a signal splitter. The apparatus further comprises means such as circuitry for receiving a network signal from a first one of the plurality of external devices and controlling a gain of the network signal responsive to a control signal from a second one of the plurality of external devices to thereby generate a reflected network signal. The reflected network signal is output to the second one of the plurality of external devices.

In accordance with another aspect of the present invention, a method is disclosed. According to an exemplary embodiment, the method comprises receiving via a first terminal of an apparatus, a broadcast signal from a signal source; outputting via a second terminal of the apparatus, the broadcast signal to a plurality of external devices coupled to the apparatus via a signal splitter; receiving, via the second terminal of the apparatus, a network signal from a first one of the plurality of external devices; controlling a gain of the network signal responsive to a control signal from a second one of the plurality of external devices to thereby generate a reflected network signal; and outputting, via the second terminal of the apparatus, the reflected network signal to the second one of the plurality of external devices.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagram of an exemplary video home network having three levels of signal splitting;

FIG. 2 is a diagram of a video home network having a reflector apparatus according to an exemplary embodiment of the present invention;

FIG. 3 is a diagram of the reflector apparatus of FIG. 2 according to an exemplary embodiment of the present invention;

FIG. 4 is a diagram of the reflector apparatus of FIG. 2 according to another exemplary embodiment of the present invention; and

FIG. 5 is a flowchart illustrating a method according to an exemplary embodiment of the present invention.

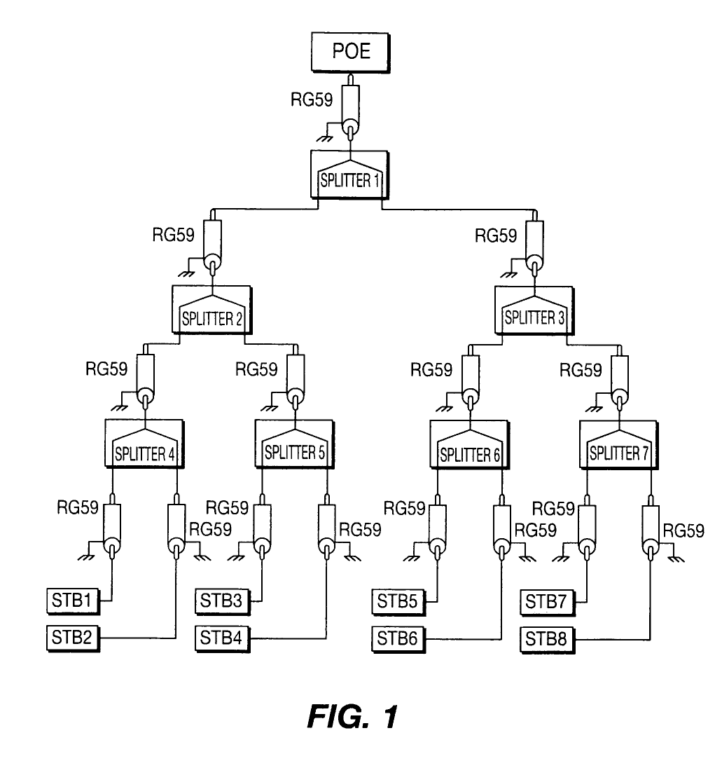

The exemplifications set out herein illustrate preferred embodiments of the invention, and such exemplifications are not to be construed as limiting the scope of the invention in any manner.

### DESCRIPTION OF THE PREFERRED EMBODIMENTS

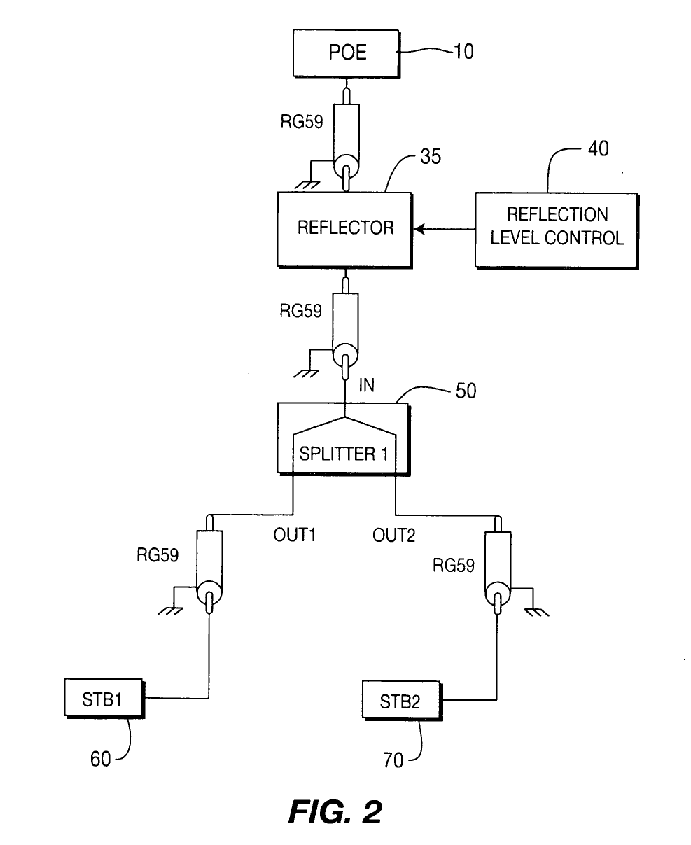

Referring now to the drawings, and more particularly to FIG. 2, a diagram of a video home network having a reflector apparatus 30 according to an exemplary embodiment of the present invention is shown. The video home network of FIG. 2 comprises a point-of-entry (POE) 10, a reflector 35, a reflection level control block 40, a signal splitter 50, and a plurality of external devices 60 and 70. For purposes of example and explanation, only two external devices 60 and 70 are shown in FIG. 2, and these devices are represented as set-top boxes (STB1 and STB2). However, in practice, the number of external devices included in the video home network may be greater than two (requiring additional signal splitters), and such devices may be embodied as other types of electronic devices (e.g., television, DVD player, etc.). Also in FIG. 2, the elements of the video home network are shown as being coupled via RG-59 coaxial cable. In practice, however, other types of transmission mediums may also be used.

In a first mode of operation, reflector 35 receives a broadcast signal from POE 10 and outputs the broadcast signal for distribution to external devices 60 and 70 via signal splitter 50. According to an exemplary embodiment, the broadcast signal may be a satellite signal in a frequency band of 950 to 2150 MHz. However, other types of broadcast signals (e.g., cable, terrestrial, etc.) in other frequency bands may also be provided in accordance with the principles of the present invention.

In a second mode of operation (which may be performed simultaneously with the first mode of operation), one of the external devices 60 or 70 may transmit a network signal including audio and/or video content to the other external device 60 or 70 upon request. In such cases, reflector 35 is operative to generate a reflected version of the network signal responsive to a control signal. For purposes of example and explanation, FIG. 2 shows this control signal being provided from reflection level control block 40. However, according to an exemplary embodiment, this control signal is actually provided from the external device 60 or 70 that requests and receives the network signal from the other external device 60 or 70. Further details regarding reflector 35 and the aforementioned first and second modes of operation will hereinafter be provided.

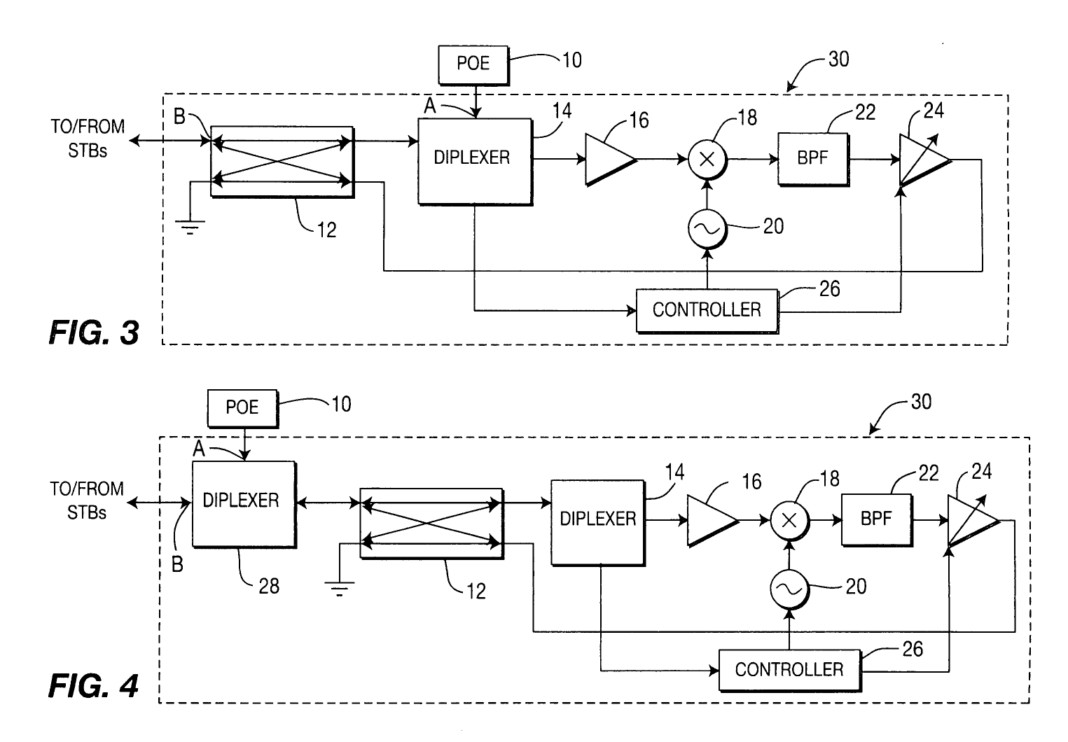

Referring now to FIG. 3, a diagram indicating particular detail of reflector 35 of FIG. 2 according to an exemplary embodiment of the present invention is shown. As indicated in FIG. 3, reflector apparatus 30 comprises a directional coupler 12, a diplexer 14, an amplifier 16, a signal multiplier 18, an oscillator 20, a band pass filter (BPF) 22, a variable gain amplifier 24, and a controller 26. It is noted that signal multiplier 18 and oscillator 20 are optional elements and may be included as a matter of design choice if reflector apparatus 30 needs to provide a frequency conversion function.

In the first mode of operation, diplexer 14 receives a broadcast signal (e.g., satellite signal) from POE 10 via a first terminal A of reflector apparatus 30. In practice, POE 10 may represent a frequency translation module (FTM), which is generally known in the art. Alternatively, POE 10 may simply represent the entry point of a transmission medium (e.g., coaxial cable) within a home or other dwelling. The received broadcast signal is passed from diplexer 14 to directional coupler 12 and output from reflector apparatus 30 at a second terminal B. The broadcast signal is then distributed over the cable network, split via signal splitter 50 and provided to external devices 60 and 70 for processing and output (see FIG. 2). According to an exemplary embodiment, diplexer 14 is configured to simply pass the relatively high frequency (e.g., 950 to 2150 MHz) broadcast signal to directional coupler 12 for output onto the network. In this manner, reflector apparatus 30 simply operates as a pass-though for the received broadcast signal during the first mode of operation and does not generate a reflected signal.

In the second mode of operation (which may be performed simultaneously with the first mode of operation), a user at one of the external devices 60 or 70 may desire to receive a network signal comprised of audio and/or video content from the other external device 60 or 70 (see FIG. 2). Such content may for example be stored on a recording medium (not shown in FIGS.) associated with one of the external devices 60 or 70. As an example, assume a user at external device 60 (STB 1) wants to receive a network signal representing desired audio and/or video content from external device 70 (STB 2). To initiate this operation, the user provides an input to external device 60 (e.g., responsive to an on-screen menu, etc.) which causes external device 60 to generate and output a request signal for such content. This request signal, which may be the same frequency as the requested network signal, passes through the network and is ultimately received by external device 70. External device 70 outputs the network signal comprised of the desired audio and/or video content responsive to the request signal. The network signal passes through signal splitter 50 and is received by reflector apparatus 30 at second terminal B. Directional coupler 12 passes the received network signal to diplexer 14 which in turn passes the network signal to amplifier 16.

According to an exemplary embodiment, the network signal exhibits a frequency that is different (i.e., higher or lower) than the aforementioned broadcast signal. In this manner, frequency selective diplexer 14 is able to detect the network signal for passage to amplifier 16. Amplifier 16 amplifies the network signal and passes the resulting amplified network signal to signal multiplier 18 which may frequency convert the network signal to a higher or lower frequency. As previously indicated herein, signal multiplier 18 and oscillator 20 are optional elements of reflector apparatus 30. The output of frequency multiplier 18 (if included) passes to BPF 22 which filters the network signal to generate a filtered network signal. This filtered network signal is then passed to variable gain amplifier 24.

In addition to the request signal, external device 60 also generates and outputs a control signal that is operated upon by reflector apparatus 30 to control the gain of the network signal provided by external device 70. According to an exemplary embodiment, the control signal is received by reflector apparatus 30 at second terminal B and passes through directional is coupler 12 to diplexer 14. Diplexer 14 receives the control signal from directional coupler 12 and passes it to controller 26. The control signal indicates a particular level of gain control to be applied to the network signal. In response to the control signal, controller 26 generates an output signal that is provided to variable gain amplifier 24 which amplifies the network signal responsive to the output signal to thereby generate a gain controlled (i.e., reflected) network signal. This reflected network signal is then passed to directional coupler 12 which outputs the reflected network signal over the network at second terminal B. The reflected network signal passes through signal splitter 50 and is received by external device 70 for processing and output. External device 70 may also adaptively generate and output the aforementioned control signal based on the received signal level of the reflected network signal and/or user input so as to optimize the signal level of the reflected network signal and provide a desired quality of service. In this manner, controller 26 may cause variable gain amplifier 24 to vary its level of amplification over time while the network signal is being received by reflector apparatus 30.

If reflector apparatus 30 includes the frequency conversion functionality provided by the optional signal multiplier 18 and oscillator 20, external device 60 may also output a control signal that causes controller 26 to control the operation of signal multiplier 18 and oscillator 20 and thereby frequency convert the network signal. Alternatively, if reflector apparatus 30 does not include the frequency conversion functionality provided by the optional signal multiplier 18 and oscillator 20, both the network signal and the reflected network signal will exhibit the same frequency.

to FIG. 4 is a diagram of reflector apparatus 30 of FIG. 2 according to another exemplary embodiment of the present invention. Reflector apparatus 30 of FIG. 4 is substantially similar to reflector apparatus 30 of FIG. 3, except for the inclusion of an additional diplexer 28. With both embodiments (i.e., FIGS. 3 and 4), the diplexers are operative to discriminate on the basis of is frequency among broadcast signals (which are simply passed from POE 10 to devices 60 and 70), request and network signals (which are processed by amplifier 16, BPF 22, and variable gain amplifier 24, and possibly signal multiplier 18), and control signals (which are passed to controller 26 for control purposes). The control signals may be for example exhibit a lower frequency than the broadcast signals and the request and network signals.

By generating the reflected network signal in the aforementioned manner, reflector apparatus 30 of both embodiments are able to create a differential between the signal levels of the (non-reflected) network signal and the reflected network signal and thereby prevent the multi-path problem discussed previously herein. The architecture of reflector apparatus 30 is also desirable from a cost standpoint, and its functionality as described herein provides immunity from the performance of signal splitters in a video home network.

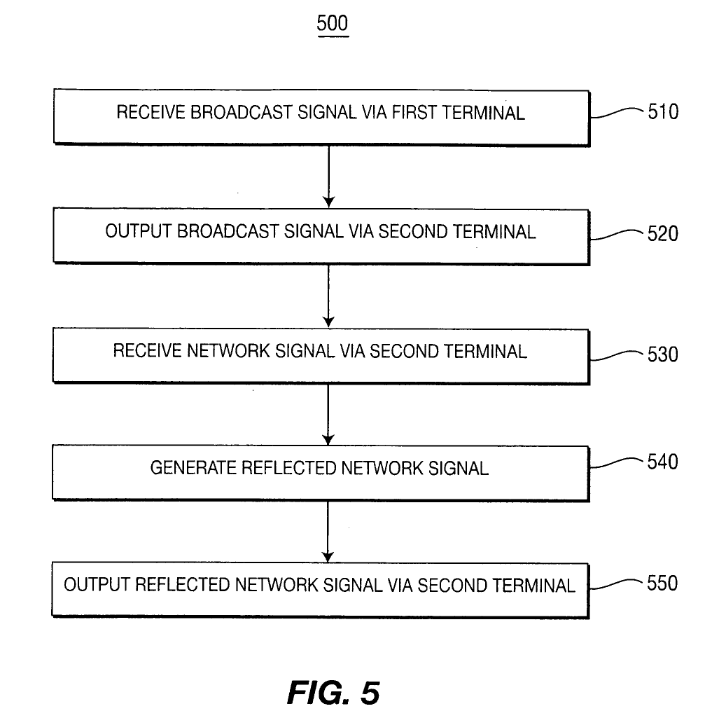

Referring to FIG. 5, a flowchart 500 illustrating a method using embodiments of the present invention is shown. For purposes of example and explanation, the steps of FIG. 5 will be described with reference to the video home network of FIG. 2 and reflector apparatus 30 of FIG. 3. The steps of FIG. 5 are exemplary only, and are not intended to limit the present invention in any manner.

At step 510, reflector apparatus 30 receives a broadcast signal from POE 10 via first terminal A. According to an exemplary embodiment, the broadcast signal may be a satellite signal in a frequency band of 950 to 2150 MHz, although other types of broadcast signals (e.g., cable, terrestrial, etc.) in other frequency bands may also be received in accordance with the principles of the present invention.

At step 520, reflector apparatus 30 outputs the received broadcast signal via second terminal B. According to an exemplary embodiment, the received broadcast signal is passed from diplexer 14 to directional coupler 12 and output from reflector apparatus 30 at a second terminal B. The broadcast signal is then distributed over the cable network, split via signal splitter 50 and provided to external devices 60 and 70 for processing and output. Steps 510 and 520 are part of the first mode of operation previously described herein.

At step 530, reflector apparatus 30 receives a network signal via second terminal B from one of the external devices 60 or 70. According to an exemplary embodiment, the network signal is transmitted to reflector apparatus 30 from one of the external devices 60 or 70 responsive to a request signal sent from the other external device 60 or 70. The network signal passes through signal splitter 50 and is received by reflector apparatus 30 at second terminal B.

At step 540, reflector apparatus 30 generates a reflected network signal using the received network signal. According to an exemplary embodiment, directional coupler 12 passes the received network signal to diplexer 14 which in turn passes the network signal to amplifier 16. As previously indicated herein, the network signal exhibits a frequency that is different than the aforementioned broadcast signal and control signal received by reflector apparatus 30. Amplifier 16 amplifies the network signal and passes the resulting amplified network signal to signal multiplier 18 which may frequency convert the network signal to a higher or lower frequency. As previously indicated herein, signal multiplier 18 and oscillator 20 are optional elements of reflector apparatus 30. The output of frequency multiplier 18 (if included) passes to BPF 22 which filters the network signal to generate a filtered network signal. The filtered network signal is then passed to variable gain amplifier 24 which amplifies the filtered network signal responsive to an output signal provided from controller 26 to thereby generate the reflected network signal. As previously indicated herein, the output signal from controller 26 is generated responsive to a control signal provided from the external device 60 or 70 that requests and receives the reflected network signal. Also previously indicated herein, the external device 60 or 70 that requests and receives the reflected network signal may also adaptively generate and output the aforementioned control signal based on the received signal level of the reflected network signal and/or user input so as to optimize the signal level of the reflected network signal and provide a desired quality of service. In this manner, controller 24 may cause variable gain amplifier 24 to vary its level of amplification over time while the network signal is being received by reflector apparatus 30.

At step 550, reflector apparatus 30 outputs the reflected network signal via second terminal B to the other external device 60 or 70. According to an exemplary embodiment, the reflected network signal output from variable gain amplifier 24 passes through directional coupler 12 and is output onto the network at second terminal B for subsequent receipt by the external device 60 or 70 that requested the same. Steps 530 to 550 are part of the second mode of operation previously described herein, which may be performed simultaneously with the previously described first mode of operation represented by steps 510 and 520.

As described herein, the present invention provides a reflector apparatus that improves signal quality within video home networks. While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An apparatus, comprising:
a terminal (B) for providing a program signal and a modified signal to a first device and a second device and for receiving a first signal from said first device and a second signal from said second device; and
a processor for controlling a characteristic of said first signal in response to said second signal to produce said modified signal.

2. The apparatus of claim 1 wherein said processor controls a reflector and wherein said modified signal is a reflected image of said first signal.

3. The apparatus of claim 2 wherein the magnitude of the modified signal is controlled in response to said second signal.

4. The apparatus of claim 2 wherein said reflector further comprises a directional coupler and a variable gain amplifier.

5. The apparatus of claim 1 further comprising a oscillator and a signal multiplier operative to adjust the frequency of said modified signal.

6. The apparatus of claim 1 wherein said program signal, first signal and modified signal comprise video or audio content.

7. The apparatus of claim 1, wherein said characteristic of said first signal is amplitude.

8. The apparatus of claim 1 wherein said second signal indicates a magnitude of said first signal at said second device.

9. A method, comprising:
providing a program signal to first device and second device via a terminal (B);
receiving a first signal from the first device and a second signal from the second device via the terminal (B);
controlling a characteristic of the first signal responsive to the second signal to produce a modified signal; and
transmitting the modified signal to the first device and the second device via the terminal (B).

10. The method of claim 9 wherein said controlling step comprises controlling the magnitude of a reflected image of said first signal.

11. The method of claim 10 wherein the magnitude of the modified signal is controlled in response to said second signal.

12. The method of claim 9 wherein said controlling step comprises adjusting the frequency of said modified signal.

13. The method of claim 9 wherein said program signal, first signal and modified signal comprise video or audio content.

14. The method of claim 9, wherein said characteristic of said first signal is amplitude.

15. The method of claim 9 wherein said second signal indicates a magnitude of said first signal at said second device.

16. An apparatus, comprising:
a means for coupling (B) a program signal and a modified signal to a first device and a second device
a means for receiving (B) a first signal from said first device and a second signal from said second device; and
a means for controlling a characteristic of said first signal in response to said second signal to produce said modified signal.

17. The apparatus of claim 16 further comprising a means for reflecting a signal operative to generate said modified signal by reflecting a portion of said first signal.

18. The apparatus of claim 17 wherein the magnitude of the modified signal is controlled in response to said second signal.

19. The apparatus of claim 17 wherein said means for reflecting a signal comprises a directional coupler and a variable gain amplifier.

20. The apparatus of claim 16 further comprising a oscillator and a signal multiplier operative to adjust the frequency of said modified signal.
